(19) United States
(12) Patent Application Publication
(10) Pub. No.: US 2023/0323517 A1
(43) Pub. Date: Oct. 12, 2023

(54) WEAR-RESISTANT, HIGH-TEMPERATURE, REDUCED-COBALT ALLOYS FOR WELDING AND OTHER APPLICATIONS

(71) Applicant: Weldmold Co., Brighton, MI (US)

(72) Inventor: Christina Miller, Fowlerville, MI (US)

(21) Appl. No.: 17/718,715

(22) Filed: Apr. 12, 2022

(51) Int. Cl. C22C 38/58; C22C 38/52; C22C 38/44; C22C 38/56; B23K 35/02; B23K 35/30

(52) U.S. Cl. CPC C22C 38/58; C22C 38/52; C22C 38/44; C22C 38/56; B23K 35/0261; B23K 35/3086; B23K 2103/02

(57) ABSTRACT

An iron-based welding and forging alloy with a complex chemistry produces a dense, homogenous weld deposit that is resistant to hardness loss at elevated temperatures with less reliance on cobalt content. Such an alloy may comprise, in approximate percentages by weight: cobalt: 5-25; chromium: 7-14; tungsten: 2.5-10; molybdenum: 2-9; nickel: 1-6; carbon: 0.01-5; manganese: 0.01-3; with iron and residual elements comprising the balance. The residual elements may include one or more of the following: silicon, vanadium, phosphorus, and sulfur. The amounts of the residual elements may be up to 1% by weight. The inventive alloys may be provided in any suitable form for welding purposes, including metal-core TIG (GTAW), coated electrode (SMAW) and metal-core-wire (MCAW). The inventive alloy combinations may be fabricated as welding filler, providing resistance to high temperature softening, facilitating use in applications that previously dictated a specific cobalt-based material.

### FIELD OF THE INVENTION

This invention relates generally to high-temperature alloys and, in particular, to ferrous S with reduced nickel content applicable to welding processes.

### BACKGROUND OF THE INVENTION

In welding and other industries, cobalt-based alloys offer superior resistance to wear and softening when exposed to elevated temperatures, as well as resistance to galling and displacement under compression. Commonly employed in the forging industry, cobalt-based alloys are used as a weld filler to act as a shear edge in forged, component-trim tooling where excess material is removed as part of the finishing process. Performed when the forged component is at extreme elevated temperature, the trim process places the trim edge under severe thermal and mechanical stress.

Traditionally, cobalt-based alloys have performed very well in demanding applications, but availability and cost have made continued reliance on cobalt-based alloys problematic. One such alloy is Stellite®, actually a family of high-temperature cobalt-based alloys. In addition to cobalt, Stellite alloys typically contain tungsten or molybdenum, as well as lesser but importance amounts of carbon.

The typical chemical composition of Stellite 1 is provided below in TABLE I:

TABLE I

| ELEMENT | % WEIGHT |
|---|---|
| Cobalt | 57 |
| Chromium | 28-32 |
| Tungsten | 11-13 |
| Carbon | 2-3 |
| Silicon | 1.20 |
| Iron | 1 |
| Nickel | 1 |
| Other | 1.5 |

As can be seen from TABLE I, the typical Stellite alloy is more than half cobalt by weight. Unfortunately, the recent global shift in the availability of cobalt has created volatile pricing and unreliable lead times. The increasing use of cobalt as an element in high energy-density batteries has created gaps in the supply chain, increased lead times and rapidly increasing prices. Because of these factors there is an immediate need for a suitable substitute that does not rely solely on the cobalt content of the alloy to provide satisfactory performance.

### SUMMARY OF THE INVENTION

This invention is directed to iron-based welding alloys with a complex chemistries that produce dense, homogenous weld deposits resistant to hardness loss at elevated temperatures. Designed for service in forging applications, the invention may prove valuable in other areas of industry that rely on cobalt-based weld performance. While term “alloy” may be used herein, it is with the understanding that the invention is in fact directed to a family of related alloys depending upon a range of compositions.

A high-temperature, wear-resistant alloy according to the invention comprises, in approximate percentages by weight, the following elements: cobalt: 5-25; chromium: 7-14; tungsten: 2.5-10; molybdenum: 2-9; nickel: 1-6; carbon: 0.01-5; manganese: 0.01-3; with iron and residual elements comprising the balance. The residual elements may include one or more of the following: silicon, vanadium, phosphorus, and sulphur. The amounts of the residual elements may be up to 1% by weight.

In accordance with a preferred embodiment, the alloy may comprise, in approximate percentages by weight: cobalt: 9.5-11; chromium: 9.3-10; tungsten: 4.2-5.3; molybdenum: 4.2-5.3; nickel: 2.4-3; carbon: 0.01-5; and manganese: 0.50. The amount of silicon may be up to 0.30%. The amount of vanadium may be up to 0.40%. The amount of phosphorus may be up to 0.03%; and the amount of sulfur may be up to 0.03%.

The alloy may be used in demanding environments, including the field of welding. The inventive alloys may be provided in any suitable form for welding purposes, including metal-core TIG (GTAW), coated electrode (SMAW) and metal-core-wire (MCAW). The inventive alloy combinations may be fabricated as welding filler, providing resistance to high temperature softening, facilitating use in applications that previously dictated a specific cobalt-based material. The fabricated welding filler is available at a greatly reduced cost to the consumer and the nature of the fabrication process translates into significantly improved lead times and ready availability.

### BRIEF DESCRIPTION OF THE DRAWINGS

FIG. 1 is a cross section illustrating the use of the invention as a cored wire electrode; and

FIG. 2 is a cross section illustrating the use of the invention in a shielded metal arc welding electrode.

### DETAILED DESCRIPTION OF THE PREFERRED EMBODIMENTS

This invention resides in a high-temperature, low-wear welding alloy with reduced reliance on cobalt content. Due to the unique chemistry, the alloy may nevertheless be used where certain cobalt-based alloys, including Stellite alloys, are traditionally used. When used as designed, the alloy may produce a homogenous weld deposit, developing an as-welded hardness of 42-60 on the Rockwell “C” scale, depending upon the precise mixture of the alloy constituents.

The properties of the invention are provided by the chemistry shown in TABLE II, below:

TABLE II

| ELEMENT | % WEIGHT |
|---|---|
| Cobalt | 5-25 |
| Chromium | 7-14 |
| Tungsten | 2.5-10 |
| Molybdenum | 2-9 |
| Nickel | 1-6 |
| Carbon | 0.01-5 |
| Manganese | 0.01-3 |
| Silicon | <1 |
| Vanadium | <1 |
| Phosphorus | <1 |
| Sulphur | <1 |
| Iron | balance |

The alloy broadly contains, by weight, carbon between 0.01-5.0%; cobalt between 5.0 and 25.0%; and a molybdenum addition of between 2-9%. Lending to this invention's performance is the inclusion of not an insignificant amount of tungsten, with a weight percentage of 2.5-10. Work hardenability is the result of a volume of nickel (1-6%), with an addition of manganese that amounts to 0.01-3%. The strength of the alloy is aided by the addition of chromium in the 7-14% range, silicon and vanadium at a weight of less than 1% each. Silicon, vanadium, phosphorus and sulphur may be provided in trace amounts, with the balance being iron.

A more specific preferred chemistry range is set forth in TABLE III, below:

TABLE III

| ELEMENT | % WEIGHT |
|---|---|
| Cobalt | 9.5-11 |
| Chromium | 9.3-10.0 |
| Tungsten | 4.2-5.3 |
| Molybdenum | 4.2-5.3 |
| Nickel | 2.4-3.0 |
| Carbon | 0.10 |
| Manganese | 0.50 |
| Silicon | 0.30 |
| Vanadium | 0.40 |
| Phosphorus | 0.03 |
| Sulphur | 0.03 |
| Iron | balance |

As evident from TABLES II, III the inventive alloy compositions disclosed herein contain substantially less cobalt, leading to reduced cost, but with excellent wear resistance and high-temperature performance comparable to Stellite. The electrode composition contains at least some of the elements of the material being targeted for replacement, but in considerably reduced volumes. Working in concert with a unique compliment of supporting elements allows the weld deposit to perform at the same level in some applications as a cobalt-based alloy. Indeed, alloys according to the invention contain less than half the cobalt of Stellite, and in some cases less than one-tenth the amount, by weight, as shown in TABLES II, III, above.

The invention provides a lower cost, more readily available high-performance, high-temperature alloy for use in difficult application environments, including the field of welding. The inventive alloys may be fabricated as welding filler providing resistance to high temperature softening, permitting their use in applications that previously dictated a specific cobalt-based material. The fabricated welding filler may be provided at a greatly reduced cost to the consumer, and the nature of the fabrication process translates into significantly improved lead times and ready availability.

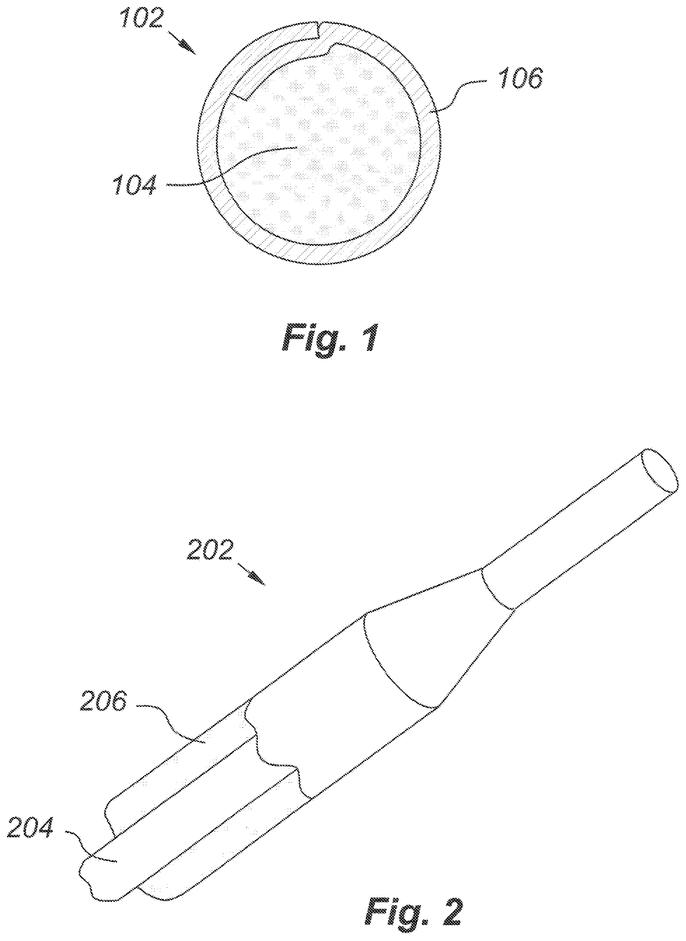

The inventive alloys may be provided in any suitable form for welding purposes, including metal-core TIG (GTAW), coated electrode (SMAW) and metal-core-wire (MCAW). FIG. 1 is a cross section illustrating the use of the invention as a cored wire electrode 102, wherein the inventive alloy is provided as a fine, highly mixed powder (with arc stabilizers and de-oxidizers) 104, surrounded by an outer steel sheath 106. The cored wire may be fabricated with any known suitable method, including the process described in U.S. Pat. No. 7,950,126, incorporated herein by reference. FIG. 2 is a cross section illustrating the use of the invention in a shielded metal arc welding electrode 202. In this application, the cored wire 204 is surrounded or encased in an extruded alloy flux coating 206 with arc stabilizers and de-oxidizers. The flux coating may be a water-or silicate-based mixture that is dried or hardened around the core 204.

Note that, depending upon the final product configuration, some of the trace elements listed in TABLES II, III may be derived from sheath material. For example, assuming the sheath is steel, some or all contributions of carbon, manganese and silicon may be provided by the sheath. If such materials are sufficient or unintentional, additional amounts may not be added per the TABLES above. Again, while examples of welding electrodes are described, the invention may be used in any application requiring durable, wear-resistant elements or alloys, including tools and tool edges associated with drills, blades, pads and other implements for cutting, grinding, sanding, polishing, drilling, etc.

1. A high temperature, wear-resistant, low-cobalt alloy for high-temperature applications comprising, in approximate percentages by weight:
cobalt: 9.5-11.0;
chromium: 9.3-10.0;
tungsten: 4.2-5.3;
molybdenum: 4.2-5.3;
nickel: 2.4-3.0;
carbon: 0.10;
manganese: 0.50 and
iron and other elements: balance.

2. The alloy of claim 1, wherein the other elements include one or more of the following: silicon, vanadium, phosphorus, and sulphur.

3. The alloy of claim 2, wherein the amount of silicon is up to 1% by weight.

4. The alloy of claim 2, wherein the amount of vanadium is up to 1% by weight.

5. The alloy of claim 2, wherein the amount of phosphorous is up to 1% by weight.

6. The alloy of claim 2, wherein the amount of sulphur is up to 1% by weight.

7.-11. (canceled)

12. A welding electrode including the alloy of claim 1.

13. (canceled)

14. A tool including the alloy of claim 1.

15. (canceled)
